(19) United States
(12) Patent Application Publication
(10) Pub. No.: US 2026/0057053 A1
(43) Pub. Date: Feb. 26, 2026

(54) INFORMATION PROCESSING DEVICE, AUTHENTICATION METHOD, AND STORAGE MEDIUM

(71) Applicant: NEC CORPORATION, Minato-ku, Tokyo (JP)

(72) Inventor: Masato SASAKI, Tokyo (JP)

(73) Assignee: NEC CORPORATION, Minato-ku, Tokyo (JP)

(21) Appl. No.: 19/102,887

(22) PCT Filed: Aug. 25, 2022
(86) PCT No.: PCT/JP2022/032039

§ 371 Date: Feb. 11, 2025

(51) Int. Cl. G06F 21/32

(52) U.S. Cl. CPC G06F 21/32

(57) ABSTRACT

An information processing device calculates a probability that biometric information corresponds to a subject, or the biometric information does not correspond to the subject, based on a first score indicating a degree to which the subject is spoofed and a second score indicating the degree of similarity between the biometric information and registered biometric information, and performs authentication related to the subject based on the probability.

### TECHNICAL FIELD

This disclosure relates to an information processing device, an authentication method, and a storage medium.

### BACKGROUND ART

Biometric authentication is one of the authentication technologies for identifying individuals. Biometric authentication makes it possible to identify individuals by extracting characteristics from biometric information such as the face or iris, and is a highly convenient authentication method for users as it does not require operations such as entering a password. However, such biometric authentication technology has the problem of spoofing, that is, a person impersonating another person. For example, the problem of spoofing involves presenting another person's biometric information to an authentication device using printed image or a display, and the authentication device mistakenly determining that the person is a registered person.

An example of a spoofing determination method for preventing such spoofing is shown in Patent Document 1. In the face authentication technique disclosed in Patent Document 1, a determination of spoofing is made based on the distance between two points by using the unevenness of an actual face and the difference in distance from the background. Authentication is performed only if a determination of spoofing is not made.

Patent Document 2 discloses a method for determining spoofing in multimodal authentication that uses multiple types of biometric information for authentication. In Patent Document 2, a collation score representing the degree of similarity between biometric information acquired from a subject and a registered person is calculated, and the collation score of each piece of biometric information is used to calculate a spoofing score to determine spoofing.

### PRIOR ART DOCUMENTS

### Patent Documents

Patent Document 1: Japanese Unexamined Patent Application Publication No. 2007-241402
Patent Document 2: Japanese Patent Application No. 2015-502739

### SUMMARY OF INVENTION

### Problems to be Solved by the Invention

The present disclosure aims to provide an information processing device, an authentication method, and a storage medium that aim to improve upon the prior art documents mentioned above.

### Means for Solving the Problem

According to a first example aspect of the present invention, an information processing device comprises: a probability calculation means for calculating, under a predetermined condition, a probability that acquired biometric information is determined to correspond to a subject, or a probability that the acquired biometric information is determined not to correspond to the subject, based on a spoofing score indicating the degree to which the subject is spoofed and a collation score of biometric information relating to the subject; and an authentication means for performing authentication of the subject based on the probability.

According to a second example aspect of the present invention, an authentication method comprises: calculating, under a predetermined condition, a probability that acquired biometric information is determined to correspond to a subject, or a probability that the acquired biometric information is determined not to correspond to the subject, based on a spoofing score indicating the degree to which the subject is spoofed and a collation score of biometric information relating to the subject; and performing authentication of the subject based on the probability.

According to a third example aspect of the present invention, a storage medium stores a program that causes a computer of an information processing device to function as a probability calculation means for calculating, under a predetermined condition, a probability that acquired biometric information is determined to correspond to a subject, or a probability that the acquired biometric information is determined not to correspond to the subject, based on a spoofing score indicating the degree to which the subject is spoofed and a collation score of biometric information relating to the subject; and an authentication means for performing authentication of the subject based on the probability.

### BRIEF DESCRIPTION OF DRAWINGS

FIG. 1 illustrates a functional block diagram of the information processing device according to the first example embodiment of the present disclosure.

FIG. 2 illustrates a flowchart showing a process executed by the information processing device in the first example embodiment.

FIG. 3 illustrates a functional block diagram of the information processing device according to the second example embodiment of the present disclosure.

FIG. 4 illustrates a flowchart showing a process executed by the information processing device according to the second example embodiment.

FIG. 5 illustrates a functional block diagram of the information processing device according to the third example embodiment of the present disclosure.

FIG. 6 illustrates a flowchart showing a process executed by the information processing device according to the third example embodiment.

FIG. 7 illustrates a functional block diagram of the information processing device according to the fourth example embodiment of the present disclosure.

FIG. 8 illustrates a flowchart showing a process executed by the information processing device according to the fourth example embodiment.

FIG. 9 illustrates a functional block diagram of the information processing device according to the fifth example embodiment of the present disclosure.

FIG. 10 illustrates a flowchart showing a process executed by the information processing device in the fifth example embodiment.

FIG. 11 illustrates a diagram illustrating a hardware configuration of an information processing device.

### EXAMPLE EMBODIMENTS

Hereinbelow, an information processing device according to an example embodiment of the present disclosure will be described with reference to the drawings.

### First Example Embodiment

### Description of Configuration

FIG. 1 is a functional block diagram of the information processing device according to a first example embodiment of the present disclosure.

An information processing device 101 is a unimodal authentication device. Unimodal means a single format, and a unimodal authentication device performs authentication using one piece of biometric information. The information processing device 101 may be an authentication device that performs multi-modal (multiple types of) authentication using multiple pieces of biometric information. The information processing device 101 performs the functions of a biometric information processing portion 105 consisting of a collation score calculation portion (collation score calculation means) 102, a spoofing score calculation portion (spoofing score calculation means) 103, and a probability calculation portion (probability calculation means) 104, and a determination portion 106 (authentication means). In the first example embodiment, a case will be described in which the information processing device 101 operates as a unimodal authentication device.

The collation score calculation portion 102 compares the biometric information acquired from the subject to be collated with biometric information of the same part of the subject that has been registered in advance, and calculates the similarity with the registered biometric information as a collation score.

The spoofing score calculation portion 103 calculates a spoofing score that quantifies whether the biometric information acquired from the subject to be collated indicates spoofing or a genuine biometric. The spoofing score indicates the degree to which the subject is an impostor.

The probability calculation portion 104 calculates, based on the spoofing score and the collation score of the subject's biometric information, the probability that the acquired biometric information will be determined to correspond to the subject (true person probability) or the probability that the acquired biometric information will be determined to not correspond to the subject (other person probability) under specified conditions.

The biometric information processing portion 105 is provided with a collation score calculation portion 102, a spoofing score calculation portion 103, and a probability calculation portion 104, and calculates the true person probability or other person probability from one type of input biometric information while taking into account spoofing. Therefore, the biometric information processing portion 105 suppresses the event where another person is mistakenly authenticated as a registrant using spoofed biometric information.

The determination portion 106 is one example aspect of an authentication means, and determines whether the input biometric information is the biometric information of a registered subject or is not the biometric information of any registered subject based on the true person probability or other person probability calculated by the probability calculation portion 104.

### Operation Description

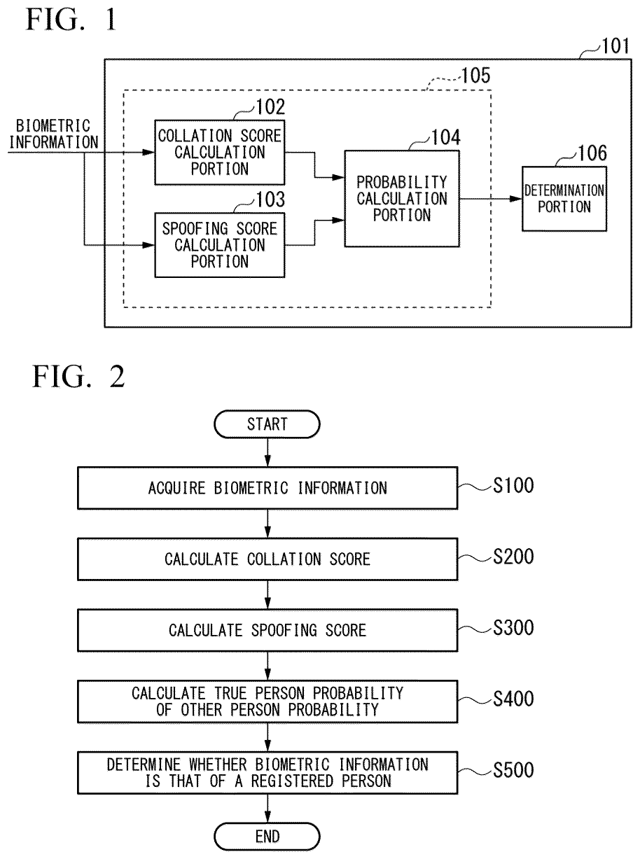

FIG. 2 is a flowchart showing the process executed by the information processing device 101.

Next, the operation of the information processing device 101 will be described with reference to the flowchart of FIG. 2.

The information processing device 101 acquires biometric information of a subject performing identity verification (Step S100). The biometric information processing portion 105 then passes the biometric information to the collation score calculation portion 102 and the spoofing score calculation portion 103. Biometric information is information capable of identifying an individual, such as a face image, an iris image, a fingerprint image, a vein image, or a speech signal.

The collation score calculation portion 102 calculates a collation score based on the degree of similarity between the acquired biometric information and biometric information stored by prior registration (Step S200). Several methods have been proposed for calculating the collation score, including a method that uses deep learning to extract features from biometric information and calculates the similarity with pre-stored biometric information. In the present disclosure, any method may be adopted as long as it calculates a value indicating the similarity between the acquired biometric information and the biometric information stored by pre-registration.

The spoofing score calculation portion 103 extracts biometric or spoofing characteristics from the acquired biometric information, and calculates the spoofing score (Step S300). The processes of steps S200 and S300 may be performed in parallel. Examples of spoofing using images in biometric authentication include spoofing using printed image and spoofing using a display. In such spoofing, biometric information of another person is printed or displayed on a screen and presented to a device for authentication to spoof that person. In order to detect such spoofing, various methods have been proposed for calculating a spoofing score from biometric information. As an example, methods for detecting spoofing using the iris include a method that uses an iris image as input and calculates the spoofing score using deep learning, a method that uses machine learning to calculate the spoofing score from local features based on changes in image shading and image quality indexes, and a method that calculates the spoofing score from unique biometric eye movements and gaze patterns obtained from video footage. A local feature amount based on the change in shading of an image is calculated using a method such as Scale-Invariant Feature Transform (SIFT), Speeded-Up Robust Features (SURF), or Histograms of Oriented Gradients (HOG). The processing of the spoofing score calculation portion 103 in the information processing device 101 of the present disclosure may use any of these methods.

The spoofing score calculation portion 103 may calculate the spoofing score by using information such as distance information that is acquired in conjunction with the acquisition of biometric information, as in Patent Document 1. Furthermore, the spoofing score calculation portion 103 may be provided with a plurality of spoofing score calculation methods. In this case, the spoofing score may be expressed in a vector format so that multiple spoofing score values can be referenced by the probability calculation portion 104.

The probability calculation portion 104 obtains the collation score from the collation score calculation portion 102. Furthermore, the probability calculation portion 104 obtains the spoofing score from the spoofing score calculation portion 103. The probability calculation portion 104 calculates a true person probability for the biometric information of the person to be authenticated acquired in Step S100, based on the acquired collation score and spoofing score (Step S400). The probability calculation portion 104 may calculate the other person probability for the biometric information of the person to be authenticated obtained in Step S100. The true person probability is the probability that, under the conditions under which the spoofing score acquired by the probability calculation portion 104 is calculated, the biometric information acquired based on the collation score acquired by the probability calculation portion 104 is determined to correspond to the identity of the person whose biometric information is stored in advance. The other person probability is the probability that, under the conditions under which the spoofing score acquired by the probability calculation portion 104 is calculated, the biometric information acquired based on the collation score acquired by the probability calculation portion 104 is determined to correspond to another person different from the biometric information previously stored. In the present disclosure, the probability calculation portion 104 may calculate either a true person probability or another person probability. As an example, the probability calculation portion 104 calculates the other person probability p using the following equation.

$$[ Equation 1 ]$$

$$p = P ( f \vert g ) \qquad ( 1 )$$

In Equation (1), f represents the collation score and g represents the spoofing score. In this way, the other person probability p can be expressed as the conditional probability P of the spoofing score g and the collation score f.

According to the above-mentioned process, the probability calculation portion 104 corrects the relationship between the collation score and the true person probability (or the other person probability). That is, in a case where the probability of spoofing is high based on the acquired collation score and spoofing score, the probability calculation portion 104 performs a correction so that the true person probability decreases and the other person probability increases. In other words, even if the calculated collation score is a value that is determined to be close to the true person, if the spoofing score is high, the probability calculation portion 104 performs a correction so that the true person probability is low and the other person probability is high.

The probability calculation portion 104 may calculate the true person probability or the other person probability using a lookup table indicating the relationship between the spoofing score, the collation score, and the true person probability or the other person probability. This lookup table receives two inputs, a collation score and a spoofing score, and outputs a true person probability or an other person probability. The lookup table predetermines the distribution of the collation score obtained from the collation score calculation portion 102 in accordance with the acquired biometric information and the distribution of the spoofing score obtained from the spoofing score calculation portion 103 in accordance with the acquired biometric information, and shows the relationship between the distribution of these scores and the true person probability or other person probability corresponding to each value of a predetermined score in the distribution of scores. In a case where a lookup table is used, the probability calculation portion 104 reads the lookup table from a memory that stores information about the lookup table, and calculates the true person probability or the other person probability. By using this lookup table, the probability calculation portion 104 is expected to quickly calculate the true person probability or the other person probability based on the acquired collation score and spoofing score.

The probability calculation portion 104 may mathematically express the relationship between the collation score and the spoofing score and the true person probability or the other person probability, generate a learning model based on machine learning of the relationship, or generate a learning model based on deep learning of the relationship, and use these mathematical formulas and learning models to calculate the true person probability and the other person probability. In a case where generating this learning model, the collation score and the spoofing score are used as inputs, and the true person or other person probability is used as output, and a regression model is used to generate the model. To calculate the parameters of this learning model, learning is performed as to whether the data corresponds to the registered individual, another person, or a spoofing attempt by analyzing collation scores and spoofing scores derived from biometric information obtained from both the biometrics and spoofing. In a case where using a regression model, processing time increases depending on the complexity of the learning model, but the number of parameters to be stored in memory can be reduced compared to a lookup table, and improved memory efficiency of the information processing device 1 of the present disclosure can be expected.

The determination portion 106 acquires the calculated true person probability or other person probability. The determination portion 106 determines whether the biometric information of the person subject to identity verification is that of a person registered in the information processing device 101, based on the obtained true person probability or other person probability (Step S500). Alternatively, the determination portion 106 may determine which specific person registered in the information processing device 101 the biometric information of the person subject to identity verification belongs to, based on the acquired true person probability or other person probability. The determination portion 106 compares the true person probability or other person probability with a preset threshold value to determine whether the biometric information acquired by the information processing device 101 belongs to a registered person or to which specific registered person it belongs to, and indicates to the person subject to identity verification whether the authentication was successful or unsuccessful.

The threshold value for the true person probability or the other person probability used by the determination portion 106 is calculated in advance using biometric information of multiple persons and other people including spoofing, and is set so as to minimize false detections and false acceptances based on the true person distribution of this true person probability and other person probability and other person distribution including spoofing attempts.

According to the processing of the information processing device 101 described above, the probability calculation portion 104 calculates the true person probability or other person probability under the condition where the spoofing score is the calculated value, so it is possible to calculate the true person probability or other person probability that takes spoofing into account. In this way, in a case where the possibility of spoofing is high, the collation score and the spoofing score are used to correct the true person probability to a low value and the other person probability to a high value. Therefore, the information processing device 101 can reduce the risk of erroneous acceptance caused by authenticating a spoofed authentication target as a genuine individual. Furthermore, the information processing device 101 determines whether a subject is the true person or a different person by using a true person probability or other person probability, rather than a binary determination for the spoofing score. Therefore, while the number of false detections and false acceptances increases in a case where a score near a threshold value is displayed in a case where making a binary judgment on the spoofing score, in the above-mentioned information processing device 101, by using the true person probability or other person probability calculated from both the spoofing score and the collation score, it is possible to avoid situations where an ambiguous determination result is obtained using only the spoofing score, thereby providing a more accurate and robust authentication method.

### Second Example Embodiment

### Description of Configuration

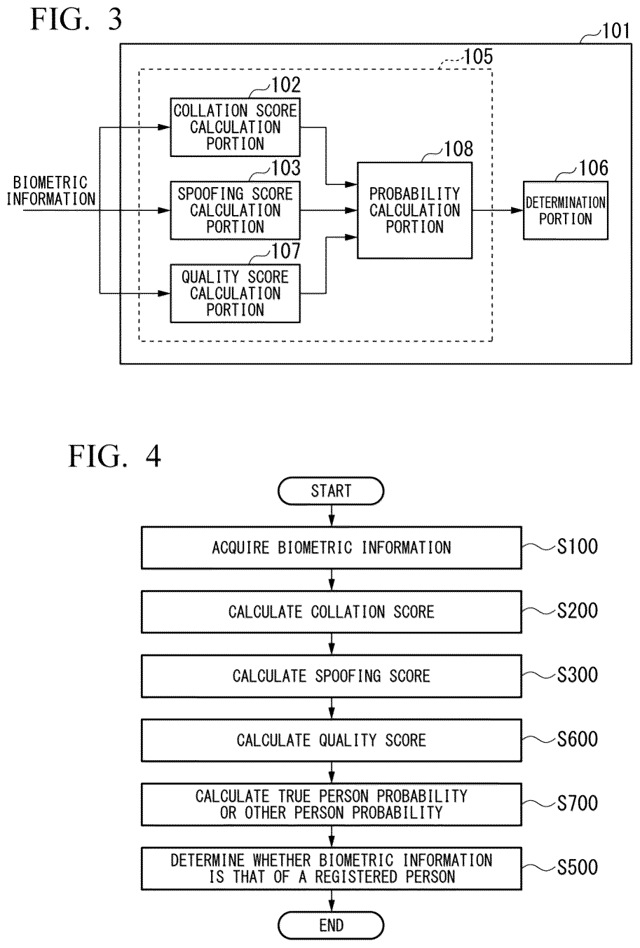

FIG. 3 is a functional block diagram of the information processing device according to a second example embodiment of the present disclosure.

In the information processing device 101 of the second example embodiment, the biometric information processing portion 105 described in the first example embodiment further includes a quality score calculation portion (quality score calculation means) 107. In the second example embodiment, a case will be described in which the information processing device 101 operates as a unimodal authentication device.

### Operation Description

FIG. 4 is a flowchart showing the process executed by the information processing device according to the second example embodiment.

Next, the operation of the information processing device 101 will be described with reference to the flowchart of FIG. 4. In the processing of the information processing device 1 in the second example embodiment, the processing of steps S100, S200, and S300 is similar to the processing of the first example embodiment, and therefore description thereof will be omitted.

In steps S200 and S300, a collation score and an spoofing score are calculated, respectively, and the quality score calculation portion 107 calculates a quality score representing quality from the acquired biometric information (Step S600). The process of Step S600 may be performed in parallel with the processes of steps S200 and S300. Here, as examples of information indicating the quality of the biometric information, in a case where the biometric information is included in an image, the quality score calculation portion 107 calculates, as quality information, blurring of the focus, motion blur, darkness and brightness of the entire image, noise in the captured image, and the like. In the present disclosure, the quality score calculation portion 107 may calculate any element related to the quality of the acquired biometric information as quality information. In addition to the general quality of the biometric information that can be obtained from an image, if the biometric information is an iris image, for example, the quality information may include information indicating the degree to which the iris is obscured by the eyelids or glasses reflection, or the degree to which the area of the iris region shown in the image is reduced due to the orientation of the eyes relative to the camera, and the like. The information processing device 1 may use information such as the degree to which a part of the biometric information is obscured or the orientation of the target as information on the quality of the target biometric information and calculate the quality score.

The quality score calculation portion 107 may use any method for calculating the quality score. As an example, in a case where acquiring biometric information from an image, the quality score calculation portion 107 may perform a filter process on the image to calculate a quality score indicating a numerical value representing out-of-focus. Alternatively, the quality score calculation portion 107 may calculate each quality score using a plurality of methods. In this case, the quality score may be a vector-format value having values related to quality calculated according to each technique. The quality score calculation portion 107 may calculate the quality score in parallel with the calculation of the collation score in Step S200 and the calculation of the spoofing score in Step S300.

The probability calculation portion 108 obtains the collation score from the collation score calculation portion 102. Furthermore, the probability calculation portion 104 obtains the spoofing score from the spoofing score calculation portion 103. Furthermore, the probability calculation portion 104 obtains the quality score from the quality score calculation portion 107. The probability calculation portion 104 calculates the true person probability for the biometric information of the person to be authenticated acquired in Step S100, based on the acquired collation score, spoofing score, and quality score (Step S700). The probability calculation portion 104 may calculate the other person probability for the biometric information of the person to be authenticated acquired in Step S100, based on the acquired collation score, spoofing score, and quality score. The true person probability is the probability that, under the conditions under which the spoofing score and quality score acquired by the probability calculation portion 104 are calculated, the biometric information used for calculation of the collation score acquired by the probability calculation portion 104 is determined to correspond to the identity of the person whose biometric information is stored in advance. The other person probability is the probability that, under the conditions under which the spoofing score and quality score acquired by the probability calculation portion 104 are calculated, the biometric information used for calculation of the collation score acquired by the probability calculation portion 104 is determined to correspond to another person different from the biometric information stored in advance. As in the first example embodiment, the probability calculation portion 104 in the second example embodiment may calculate either the true person probability or the other person probability. As an example, the probability calculation portion 104 according to the second example embodiment calculates the other person probability p using the following Equation (2)

$$[ Equation 2 ]$$

$$p = P ( f \vert g , h ) \qquad ( 2 )$$

In Equation (2), f represents the collation score, g represents the spoofing score, and h represents the quality score. In this way, the other person probability p can be expressed as a conditional probability P of the spoofing score g, the quality score h, and the collation score f.

In a case where calculating a collation score using the biometric information contained in an image, if the image is out of focus, the collation score calculation portion 102 will not be able to fully extract the characteristics of the biometric information from the image, and the reliability of the collation score will be lower than if there was no out-of-focus. By using the quality score, the probability calculation portion 108 can calculate the true person probability or other person probability while taking into account the change in the reliability of the collation score.

The probability calculation portion 108 may calculate the true person probability or the other person probability using a lookup table indicating the relationship between the spoofing score, the quality score, the collation score, and the true person probability or the other person probability. This lookup table receives three inputs, a collation score, a spoofing score and a quality score, and outputs a true person probability or an other person probability. The lookup table predetermines the distribution of the collation score calculated by the collation score calculation portion 102 in accordance with the acquired biometric information, the spoofing score calculated by the spoofing calculation portion 103 in accordance with the acquired biometric information, and the quality score calculated by the quality score calculation portion 107 in accordance with the acquired biometric information, and shows the relationship between the distribution of these scores and the true person probability and other person probability corresponding to each value of a specified score in the distribution of the scores. In a case where a lookup table is used, the probability calculation portion 104 reads the lookup table from a memory that stores information about the lookup table, and calculates the true person probability or the other person probability. By using this lookup table, the probability calculation portion 104 is expected to quickly calculate the true person probability or the other person probability based on the acquired collation score, spoofing score, and quality score.

The probability calculation portion 104 may mathematically express the relationship between the collation score, the spoofing score, the quality score, and the true person probability or other person probability, generate a learning model based on machine learning of the relationship, or generate a learning model based on deep learning of the relationship, and use these mathematical formulas and learning models to calculate the true person probability and the other person probability. In a case where generating this learning model, the collation score, the spoofing score, and the quality score are used as inputs, and the true person or other person probability is used as output, and a regression model is used to generate the model. To calculate the parameters of this learning model, learning is performed as to whether the data corresponds to the registered true person, another person, or a spoofing attempt by analyzing collation scores, spoofing scores and quality scores derived from biometric information obtained from both the biometrics and spoofing attempts. In a case where using a regression model, processing time increases depending on the complexity of the learning model, but the number of parameters to be stored in memory can be reduced, and improved memory efficiency of the information processing device 1 of the present disclosure can be expected.

The determination portion 106 acquires the calculated true person probability or other person probability, as in the first example embodiment. The determination portion 106 determines whether the biometric information of the person subject to identity verification is that of a person registered in the information processing device 101, based on the obtained true person probability or other person probability (Step S500). Alternatively, the determination portion 106 may determine which specific person registered in the information processing device 101 the biometric information of the person subject to identity verification belongs to, based on the acquired true person probability or other person probability. The determination portion 106 compares the true person probability or other person probability with a preset threshold value to determine whether the biometric information acquired by the information processing device 101 belongs to a registered person or to which specific registered person it belongs to, and indicates to the person subject to identity verification whether the authentication was successful or unsuccessful.

The information processing device 1 of the second example embodiment calculates the true person probability and other person probability taking into account the quality of the acquired biometric information, so that improved accuracy of determination can be expected in a case where low-quality biometric information is input. In addition, since the quality of the biometric information affects both the collation score and the spoofing score, the information processing device 1 of the second example embodiment can suppress erroneous acceptance of biometric information and erroneous determination of subject authentication by additionally using a quality score.

### Third Example Embodiment

### Description of Configuration

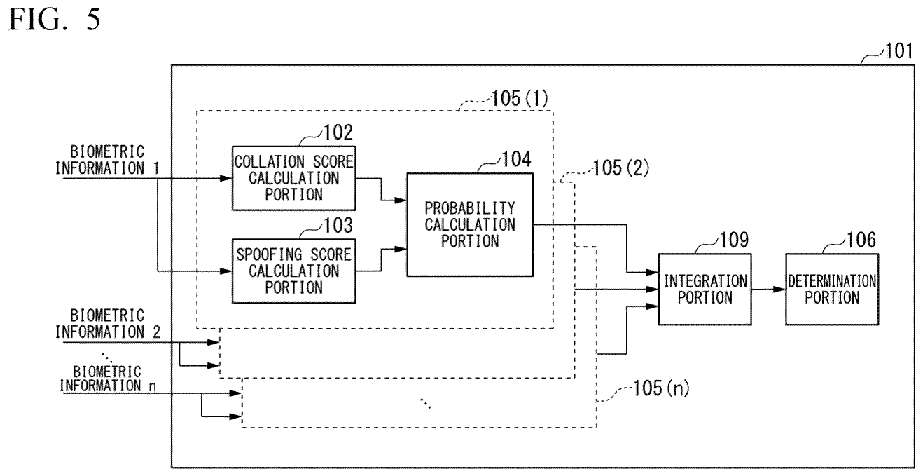

FIG. 5 is a functional block diagram of the information processing device according to a third example embodiment of the present disclosure.

The information processing device 101 of the third example embodiment includes a plurality of the biometric information processing portions 105 described in the first example embodiment. The biometric information processing portions 105 are referred to as biometric information processing portions 105(1) to 105(n). The biometric information processing portions 105(1) to 105(n) are collectively referred to as biometric information processing portions 105. In addition, in the information processing device 101 in the third example embodiment, it is not necessary for all biometric information processing portions 105 to be equipped with the spoofing calculation portion 103; it is sufficient that one or more of the n biometric information processing portions 105 are equipped with the spoofing calculation portion 103. The information processing device 101 according to the fifth example embodiment further includes an integration portion 109.

The information processing device 101 according to the third example embodiment is a multimodal authentication device that performs authentication using a plurality of different types of biometric information of an authentication subject. Therefore, the information processing device 101 includes a total of n biometric information processing portions 105 from 1 to n, which correspond to the n types of biometric information. The n types of biometric information may include a face image, an iris image, a fingerprint image, a vein image, and a speech signal. In the information processing device 101 according to the third example embodiment, two or more types of biometric information may be used in combination for authentication processing.

Furthermore, even in unimodal authentication in which the information processing device 101 inputs one type of biometric information, if the input biometric information is information from multiple locations, such as the left and right irises or fingerprints of different fingers, the authentication process may be performed by combining and using the biometric information from multiple locations.

### Operation Description

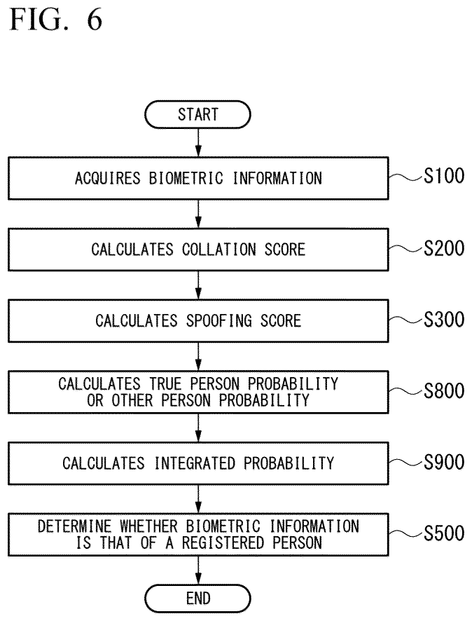

FIG. 6 is a flowchart showing a process executed by the information processing device according to the third example embodiment.

Next, the operation of the information processing device 101 will be described with reference to the flowchart of FIG. 6. In the processing of the information processing device 1 in the third example embodiment, the same processing as that in the first example embodiment will not be described.

The information processing device 1 inputs a plurality of pieces of biometric information. The biometric information processing portion 105(1) acquires a first piece of biometric information. In the biometric information processing portion 105(1), the collation score calculation portion 102, the spoofing score calculation portion 103, and the probability calculation portion 104 perform the same processes as those in the first example embodiment. That is, similar to the processing in the first example embodiment, the biometric information processing portion 105(1) of the information processing device 101 acquires biometric information in Step S100, calculates a collation score in Step S200, and calculates a spoofing score in Step S300. Then, the probability calculation portion 104 of the biometric information processing portion 105(1) calculates the true person probability or other person probability using the collation score and the spoofing score, as in the first example embodiment (Step S800). The biometric information processing portions 105(2) through 105(n) also perform the same processing as the biometric information processing portion 105(1). The integration portion 109 acquires the true person probability or other person probability from the biometric information processing portion 105(1), the biometric information processing portion 105(2), . . . , and the biometric information processing portion 105(n). In addition, any one of the biometric information processing portions 105(1) to 105(n) or a plurality of the biometric information processing portions 105 less than n may calculate the true person probability or other person probability using only the collation score. In other words, at least one of the multiple biometric information processing portions 105 may calculate the true person probability or the other person probability by using both the collation score and the spoofing score according to Equation (1).

In a case where the probability calculation portion 104 calculates the true person probability or other person probability using only the collation score, the correspondence between the collation score calculated in advance using the biometric information and the true person probability (or the other person probability) is stored. Then, the probability calculation portion 104 may calculate the true person probability (or the other person probability) based on the acquired collation score and the correspondence. The correspondence may be recorded in a lookup table. Alternatively, the information processing device 101 may learn the correspondence using a regression model, generate a learning model that takes the collation score as input and outputs the true person probability (or other person probability), and the probability calculation portion 104 may use the learning model to calculate the true person probability (or other person probability).

The integration portion 109 integrates the true person probability or other person probability corresponding to the n types of biometric information received from the biometric information processing portions 105(1) . . . (n) into a single value, and outputs an integrated probability (Step S900). The integration portion 109 may use various methods to calculate the integrated probability. As an example, in a case where the integration portion 109 calculates the other person probability, if it is considered that the other person probabilities p received from the biometric information processing portions 105(1) . . . (n) are independent of each other, it calculates the integrated probability m(p) using Equation (3).

$$[ Equation 3 ]$$

$$m ( p ) = {\prod }_{i = 1}^{n} {p}_{i} \qquad ( 3 )$$

In Equation (3), the other person probability is p={p₁, p₂, . . . , pᵢ, . . . pₙ}. In a case where it can be assumed that the other person probabilities p are independent of each other, it is possible to obtain the integrated probability m(p) as the product of the obtained other person probabilities p, as shown in Equation (3).

In addition, if differences in the rates of false detections and false acceptances are observed in a case where a large amount of data is tested in advance for the true person probability or other person probability input to the integration portion 109, or if the types of spoofing detection methods used by the spoofing score calculation portion 103 are different, the calculated integrated probability may be weighted. In this case, the integrated probability m(p) may be calculated using the other person probability p according to Equation (4).

$$[ Equation 4 ]$$

$$m ( p ) = {\prod }_{i = 1}^{n} {p}_{i} {q}_{i} \qquad ( 4 )$$

Here, the other person probability is p={p₁, p₂, . . . , pᵢ, . . . , pₙ}, and the weight (reliability) of the other person probability p is expressed as q={q₁, q₂, . . . , qᵢ, . . . , qₙ}. The reliability q corresponding to this other person probability p may be determined in advance. For example, the reliability q corresponding to the other person probability p may be determined based on the degree of false detection of the other person probability p for each different type of biometric information, or the performance difference in reliability as information used for authentication based on the false acceptance rate, etc.

The probability calculation portion 104 may calculate the true person probability or the other person probability by using a lookup table generated in the same manner as in the first example embodiment.

Alternatively, the probability calculation portion 104 may calculate the true person probability or the other person probability by using the generated learning model, as in the first example embodiment.

The determination portion 106 obtains the integrated probability that has been calculated. Based on the acquired integrated probability, the determination portion 106 determines whether the biometric information of the person subject to identity verification is a person registered in the information processing device 101, or which specific registered person it belongs to (Step S500). The determination portion 106 compares the integrated probability with a preset threshold value to determine whether the biometric information acquired by the information processing device 101 belongs to a registered person or to which specific registered person it belongs to, and indicates to the person subject to identity verification whether the authentication was successful or unsuccessful.

In the third example embodiment, the probability calculation portion 104 calculates the true person probability or other person probability under conditions where the spoofing score is a calculated value, and makes a determination of authentication using an integrated probability, which is a value obtained by integrating the true person probability or other person probability calculated for each of the different types of biometric information. This improves the accuracy of authentication even if part of the acquired biometric information is lost.

Furthermore, according to the processing of the third example embodiment, there is no need to set a threshold value for each of the multiple spoofing scores, and it is sufficient to make a determination only on the integrated probability obtained by combining the true person probability or the other person probability. Therefore, even if some of the n types of biometric information is of a quality that makes it difficult to make a spoofing determination, a determination of authentication can be made from the other types of biometric information, thereby preventing an increase in the true person rejection rate.

### Fourth Example Embodiment

### Description of Configuration

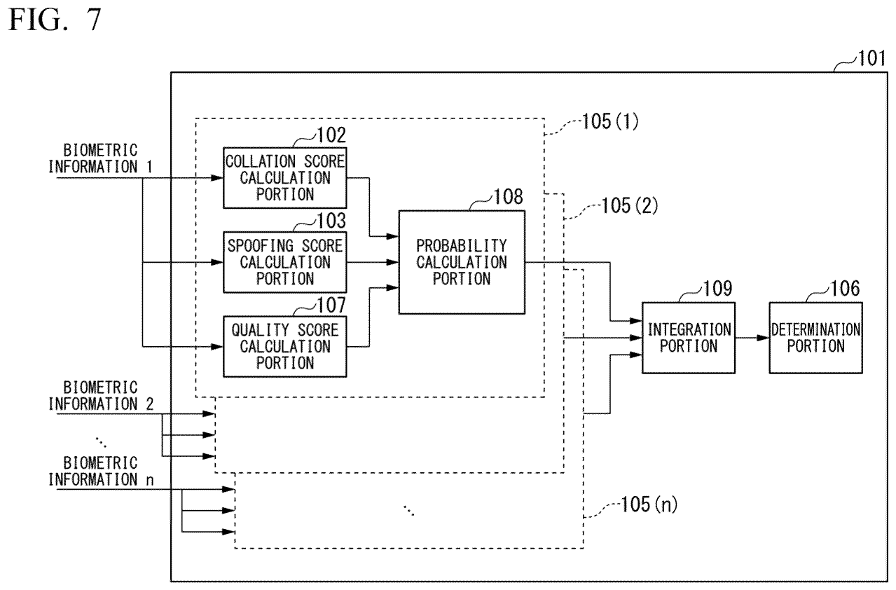

FIG. 7 is a functional block diagram of the information processing device according to a fourth example embodiment of the present disclosure.

An information processing device 101 shown in FIG. 7 is a multimodal authentication device that performs authentication based on a plurality of pieces of biometric information. The information processing device 101 of the fourth example embodiment includes a plurality of the biometric information processing portions 105 described in the second example embodiment. The biometric information processing portions 105 are referred to as biometric information processing portions 105(1) to 105(n). The biometric information processing portions 105(1) to 105(n) are collectively referred to as biometric information processing portions 105. The information processing device 101 of the fourth example embodiment further includes an integration portion 109 and a determination portion 106.

It is not necessary for all of the biometric information processing portions 105(1) . . . 105(n) to be equipped with the spoofing calculation portion 103 and the quality score calculation portion 107; it is sufficient that one or more of the n biometric information processing portions 105 are equipped with the spoofing calculation portion 103.

### Operation Description

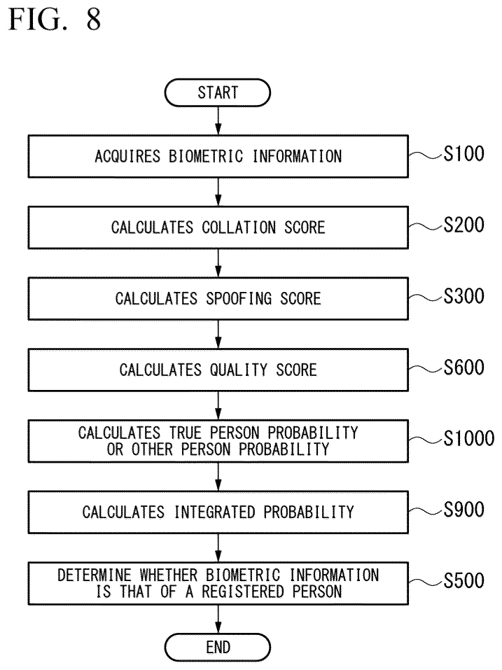

FIG. 8 is a flowchart showing a process executed by the information processing device according to the fourth example embodiment.

Next, the operation of the information processing device 101 will be described with reference to the flowchart of FIG. 8. In the processing of the information processing device 1 in the fourth example embodiment, the same processing as that in the second example embodiment will not be described.

Similar to the processing in the second example embodiment, the biometric information processing portion 105(1) of the information processing device 101 acquires biometric information in Step S100, calculates a collation score in Step S200, and calculates a spoofing score in Step S300. Furthermore, the biometric information processing portion 105(1) calculates a quality score in Step S600. The probability calculation portion 104 of the biometric information processing portion 105(1) uses the calculated collation score, spoofing score, and quality score to calculate the true person probability or the other person probability in the same way as in the second example embodiment (Step S1000). The biometric information processing portions 105(2) through 105(n) also perform the same processing as the biometric information processing portion 105(1). The integration portion 109 acquires the true person probability or other person probability from the biometric information processing portion 105(1), the biometric information processing portion 105(2), . . . , and the biometric information processing portion 105(n).

In addition, any one of the biometric information processing portions 105(1) to 105(n) or a plurality of the biometric information processing portions 105 less than n may calculate the true person probability or other person probability using only the collation score, as described in the second example embodiment. In this case, at least one of the multiple biometric information processing portions 105 calculates the true person probability or the other person probability by using the three scores, the collation score, the spoofing score, and the quality score, according to Equation (2).

Any one of the biometric information processing portions 105(1) to 105(n) or a plurality of the biometric information processing portions 105 less than n may calculate the true person probability or other person probability using two scores, the collation score and the spoofing score, as described in the second example embodiment. In this case as well, at least one of the multiple biometric information processing portions 105 calculates the true person probability or the other person probability by using the three scores, the collation score, the spoofing score, and the quality score, according to Equation (2).

Because the quality of the biometric information affects the calculation of the collation score, the quality score is used to correct the correspondence between the collation score and the true person probability or other person probability in order to add a degree of reliability to the true person probability or other person probability, such as whether the calculated collation score has sufficient quality for collation. As in the second example embodiment, the calculation of the true person probability or other person probability using the two inputs, the collation score and the quality score, may use any calculation method, such as a lookup table or regression model, in which the input is the collation score and the quality score and the output is the true person probability or other person probability.

In the information processing device 101, the other biometric information processing portions 105(2) to (n) also perform similar processing. Then, the integration portion 109 calculates an integrated probability in the same manner as in the third example embodiment, using the true person probability or the other person probability input from the biometric information processing portion 105 (Step S900). The determination portion 106 obtains the integrated probability that has been calculated. Based on the acquired integrated probability, the determination portion 106 determines whether the biometric information of the person subject to identity verification is a person registered in the information processing device 101, or which specific registered person it belongs to (Step S500). The determination portion 106 compares the integrated probability with a preset threshold value to determine whether the biometric information acquired by the information processing device 101 belongs to a registered person or to which specific registered person it belongs to, and indicates to the person subject to identity verification whether the authentication was successful or unsuccessful.

The information processing device 101 of the fourth example embodiment calculates the integrated probability by taking into account the spoofing score and the quality score. In a case where the quality of the acquired biometric information is low, the reliability of the collation score and the spoofing score decreases. Therefore, the probability calculation portion 108 converts the biometric information into a true person probability or an other person probability that takes into account spoofing and quality, and the integration portion 109 calculates an integrated probability. This makes it possible to prevent false detection and false acceptance in a case where low-quality biometric information is input.

Furthermore, the information processing device 101 of the fourth example embodiment does not need to set a threshold value for each of multiple spoofing scores, and only needs to make a determination based on the integrated true person probability or other person probability. Therefore, even if some biometric information of a quality that makes it difficult to judge spoofing is mixed in among the n different types of biometric information, by taking the quality into consideration, the weight of low-quality biometric information in the integrated true person probability or other person probability can be reduced, thereby preventing an increase in the true person rejection rate.

### Fifth Example Embodiment

### Description of Configuration

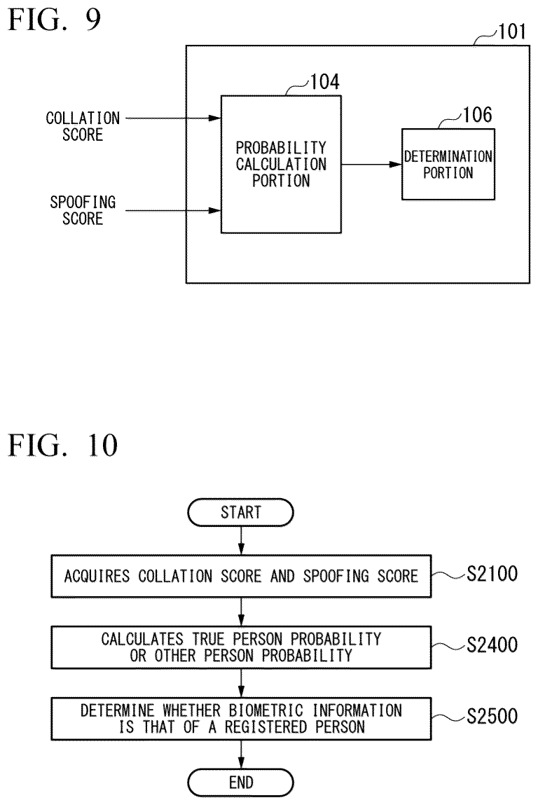

FIG. 9 is a functional block diagram of the information processing device according to a fifth example embodiment of the present disclosure.

The information processing device 101 of the fifth example embodiment performs authentication by inputting the collation score and the spoofing score of the authentication subject. As shown in FIG. 9, the information processing device 101 having a minimum configuration according to the fifth example embodiment includes at least the probability calculation portion 104 and the determination portion 106.

The probability calculation portion 104 calculates, under a predetermined condition, a probability that acquired biometric information is determined to correspond to the subject (true person probability) or the probability that the acquired biometric information is determined to not correspond to the subject (other person probability), based on a spoofing score indicating the degree to which the subject is a spoofer and a collation score of the subject's biometric information. The predetermined condition may be the condition under which the value of the acquired spoofing score was calculated.

The determination portion 106 performs authentication related to the subject's biometric information based on the true person probability or other person probability. In this authentication, the determination portion 106 determines whether the subject's biometric information is that of a registered person, based on the true person probability or other person probability calculated by the probability calculation portion 104. Also, the determination portion 106 determines to which specific registered person the subject's biometric information belongs to, based on the true person probability or other person probability calculated by the probability calculation portion 104.

By providing such a function, the information processing device 101 prevents an incident in which a person other than a registered person is mistakenly authenticated as a registered person due to spoofed biometric information.

### Operation Description

FIG. 10 is a flowchart showing a process executed by the information processing device according to the fifth example embodiment.

Next, the operation of the information processing device 101 in the fifth example embodiment will be described with reference to the flowchart of FIG. 10.

The probability calculation portion 104 of the information processing device 101 acquires the collation score and the spoofing score calculated from the biometric information of a subject performing authentication such as identity verification (Step S2100). Biometric information is information capable of identifying an individual, such as a face image, an iris image, a fingerprint image, a vein image, or a speech signal. Several means have been proposed for calculating the collation score and spoofing score obtained by the probability calculation portion 104, including, for example, a method of using deep learning to extract features from biometric information and calculate each score, but any method may be adopted in the present disclosure.

In a case where the spoofing score indicates the acquired value, the probability calculation portion 104 calculates the probability that the acquired biometric information is determined to correspond to a subject (true person probability) or the probability that the acquired biometric information is determined not to correspond to the subject (other person probability) based on the value of the acquired collation score (Step S2400). The method of calculating the probability is the same as in the other example embodiments described above.

Then, the determination portion 106 determines whether the biometric information of the subject of the identity verification belongs to a person registered in the information processing device 101, based on the calculated true person probability or other person probability (Step S2500). Alternatively, the determination portion 106 determines which specific person registered in the information processing device 101 the biometric information of the subject of the identity verification belongs to, based on the calculated true person probability or other person probability. Based on the result of the determination, the determination portion 106 notifies the subject of the identity verification that the authentication has been successful or unsuccessful.

The threshold value used by the determination portion 106 is set by calculating in advance the true person probability or other person probability from the biometric information of multiple true individuals and others, including spoofers, and based on the distribution of the true person probabilities or other person probabilities in a case where using the biometric information of the true persons and the distribution of the true person probabilities or other person probabilities in a case where using the biometric information of others, including spoofers, the threshold is set to minimize false detections and false acceptances.

According to the processing of the information processing device 101 of the fifth example embodiment described above, the probability calculation portion 104 calculates the true person probability or other person probability under the condition where the spoofing score is the calculated value, so it is possible to calculate the true person probability or other person probability that takes spoofing into account. In this way, in a case where the possibility of spoofing is high, the collation score and the spoofing score are used to correct the true person probability to a low value and the other person probability to a high value. Therefore, the information processing device 101 can reduce the risk of erroneous acceptance caused by authenticating a spoofed authentication target as a genuine individual. Furthermore, the information processing device 101 determines whether a subject is the true person or a different person by using a true person probability or other person probability, rather than a binary determination for the spoofing score. Therefore, while the number of false detections and false acceptances increases in a case where a score near a threshold value is displayed in a case where making a binary judgment on the spoofing score, in the above-mentioned information processing device 101, by using the true person probability or other person probability calculated from both the spoofing score and the collation score, it is possible to avoid situations where an ambiguous determination result is obtained using only the spoofing score, thereby providing a more accurate and robust authentication method.

### Other Example Embodiments

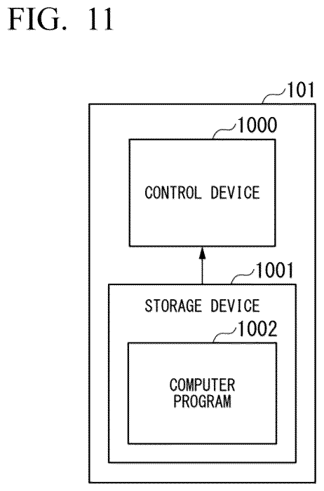

FIG. 11 is a diagram showing the hardware configuration of an information processing device.

The information processing device 101 is a computer device, and each function of the biometric information processing portion 105, which consists of the collation score calculation portion 102, the spoofing score calculation portion 103, and the quality score calculation portion 107, the probability calculation portion 104 (108), the determination portion 106, the integration portion 109, and the like is realized by a control device 1000 including a CPU (central processing unit), a GPU (graphics processing unit), or an FPGA (field programmable gate array). That is, the information processing device 101 is provided with the control device 1000 and a storage device 1001 shown in FIG. 11, and the storage device 1001 stores a computer program 1002 for controlling the operation of the information processing device 101. The control device 1000 reads the computer program 1002 from the storage device 1001 and operates in accordance with this computer program 1002 to realize each function of the information processing device 101 according to each of the above-mentioned example embodiments. Therefore, the computer program 1002 includes a computer program that causes the control device 1000 to execute processes that realize each function of the information processing device 101.

### INDUSTRIAL APPLICABILITY

As an example of how the present disclosure can be used, it is effective in improving security in entrance/exit management and payments using authentication technology.

Some or all of the above-described example embodiments can be described as, but are not limited to, the following supplementary notes. Furthermore, the configurations of the above-described example embodiments can be freely combined or modified.

### (Supplementary Note 1)

An information processing device comprising:
a probability calculation means for calculating, under a predetermined condition, a probability that acquired biometric information is determined to correspond to a subject, or a probability that the acquired biometric information is determined not to correspond to the subject, based on a spoofing score indicating the degree to which the subject is spoofed and a collation score of the subject's biometric information; and
an authentication means for performing authentication related to the subject based on the probability.

### (Supplementary Note 2)

The information processing device according to Supplementary Note 1,
wherein the biometric information is a plurality of different types of biometric information about the subject,
the probability calculation means calculates the probability for each of the plurality of different types of biometric information, and
the authentication means performs authentication relating to the subject based on a value calculated using the probability for each of the plurality of different types of biometric information.

### (Supplementary Note 3)

The information processing device according to Supplementary Note 1 or 2,
wherein the probability calculation means calculates a probability that the acquired biometric information is determined to correspond to the subject, or a probability that the acquired biometric information is determined not to correspond to the subject under a predetermined condition, the predetermined condition being the condition under which the spoofing score is obtained.

### (Supplementary Note 4)

The information processing device according to any one of Supplementary Note 1 to Supplementary Note 3,
comprising a quality score calculation means for calculating a quality score that quantifies the quality of the biometric information,
wherein the probability calculation means calculates a probability that the acquired biometric information is determined to correspond to the subject, or a probability that the acquired biometric information is determined not to correspond to the subject, under the condition in which the spoofing score and the quality score are obtained.

### (Supplementary Note 5)

The information processing device according to Supplementary Note 4,
wherein the quality score calculation means calculates a quality score of at least one of a plurality of different types of biometric information in a case where the biometric information is a plurality of different types of biometric information about the subject; and
the probability calculation means calculates, for each of the plurality of different types of biometric information, the probability based on the collation score and the spoofing score, the collation score and the quality score, the collation score, the spoofing score and the quality score, or only the collation score.

### (Supplementary Note 6)

The information processing device according to any one of Supplementary Note 1 to Supplementary Note 5, comprising:
a collation score calculation means for calculating the collation score using the subject's biometric information and pre-stored biometric information; and
a spoofing score calculation means for calculating the spoofing score from the subject's biometric information.

### REFERENCE SIGNS LIST

101 Information processing device
102 Collation score calculation portion
103 Spoofing calculation portion
104, 108 Probability calculation portion (probability calculation means)
105 Biometric information processing portion
106 Determination portion (authentication means)
107 Quality score calculation portion
109 Integration portion
1000 Control device
1001 Storage device
1002 Computer program

What is claimed is:

1. An information processing device comprising:
at least one memory configured to store instructions; and
at least one processor configured to execute the instructions to:
calculate a probability that biometric information corresponds to a subject, or the biometric information does not correspond to the subject, based on a first score indicating a degree to which the subject is spoofed and a second score indicating the degree of similarity between the biometric information and registered biometric information; and
perform authentication related to the subject based on the probability.

2. The information processing device according to claim 1,
wherein the biometric information comprises a plurality of different types of biometric information of the subject,
wherein the at least one processor is configured to execute the instructions to:
calculate the probability for each of the plurality of different types of biometric information; and
perform authentication relating to the subject based on the probability for each of the plurality of different types of biometric information.

3. The information processing device according to claim 1,
wherein the at least one processor is configured to execute the instructions to calculate the probability based on an environment under which the first score is obtained.

4. The information processing device according to claim 1,
wherein the at least one processor is configured to execute the instructions to:
calculate a third score indicating a quality of the biometric information,
calculate the probability based on an environment under which the first score and the second score are obtained.

5. The information processing device according to claim 4,
wherein the at least one processor is configured to execute the instructions to:
calculate the third score if the biometric information comprises a plurality of different types of biometric information of the subject; and
calculate the probability for each of the plurality of different types of biometric information, based on: (1) the second score or (2) the second score and at least one of the first score and the third score.

6. (canceled)

7. An authentication method execute by a computer, the method comprising:
acquiring biometric information;
calculating a probability that biometric information corresponds to a subject, or the biometric information does not correspond to the subject, based on a first score indicating a degree to which the subject is spoofed and a second score indicating the degree of similarity between the biometric information and registered biometric information; and
performing authentication related to the subject based on the probability.

8. A non-transitory storage medium storing a program that causes a computer of an information processing device to execute:
acquiring biometric information;
calculating a probability that biometric information corresponds to a subject, or the biometric information does not correspond to the subject, based on a first score indicating a degree to which the subject is spoofed and a second score indicating the degree of similarity between the biometric information and registered biometric information; and
performing authentication related to the subject based on the probability.
